(19) United States
(12) Patent Application Publication
(10) Pub. No.: US 2023/0178314 A1
(43) Pub. Date: Jun. 8, 2023

(54) Arc Binding Mechanism

(71) Applicant: UCHIYA THERMOSTAT CO., LTD., Saitama (JP)

(72) Inventor: Hideaki Takeda, Saitama (JP)

(73) Assignee: UCHIYA THERMOSTAT CO., LTD., Saitama (JP)

(21) Appl. No.: 17/919,678

(22) PCT Filed: Apr. 23, 2021
(86) PCT No.: PCT/JP2021/016407

§ 371 Date: Oct. 18, 2022

(30) Foreign Application Priority Data
Apr. 24, 2020 (JP) 2020-077617

(51) Int. Cl. H01H 33/18

(52) U.S. Cl. CPC H01H 33/18

(57) ABSTRACT

At a contact switch, an arc generated between two contacts is controlled. An arc binding mechanism 100 includes: a first contact 111 and a second contact 121 that are capable of being contacted and separated; and a substantially ring-shaped arc binder 130 that is made of a magnetic material, is electrically insulated from a circuit including the first contact and the second contact, has an axis in parallel with a direction of a gap between the first contact and the second contact in a case in which the first contact and the second contact are in a non-contact state, and is provided so as to encircle the gap.

### TECHNICAL FIELD

The present invention relates to an arc binding mechanism.

### BACKGROUND ART

Patent Document 1 describes a latch type relay that includes: a yoke around which an energized coil is wound and which internally includes a magnet; an operating member which operates between an open position and a closed position when attracted to and released from an end of the yoke by switching of energization to the energized coil; and a control contact that opens and closes current by causing a movable contact to be contacted with, and separated from, the fixed contact when the movable contact is subjected to the operation of the operating member. When the operating member is moved to the open position, opens the control contact and blocks the current, part of a magnetic flux generated at the yoke by the energized coil is superimposed on the magnetic flux of the magnet, and guides the flux as a leakage flux to the control contact side, which extends the arc generated between the movable contact and the fixed contact to the side end of the leaf spring and extinguishes the flux. The fixed contact is provided at a first fixed terminal that includes a screen-shaped main body. For contact with the fixed contact, the movable contact is provided on the leaf spring to be depressed by the action of the operating member. The upper end of the leaf spring is connected to a second fixed terminal. The second fixed terminal extends upward and forms a first electric circuit formation portion that forms an electric circuit in parallel with the longitudinal direction of the leaf spring, and forms the gap between the first electric circuit formation portion and the screen-shaped main body of the first fixed terminal so as to be smaller than the gap between the leaf spring and the screen-shaped main body of the first fixed terminal.

### CITATION LIST

[Patent Document]
[Patent Document 1] JP 2006-196362 A

### SUMMARY OF INVENTION

### Technical Problem

At the contact switch, an arc generated between the two contacts possibly damages components around the contacts. The present invention has as an object to address such an arc.

### Solution to Problem

To achieve the above object, an arc binding mechanism according to the present invention includes: a first contact and a second contact that are capable of being contacted and separated; and a substantially ring-shaped arc binder that is made of a magnetic material, is electrically insulated from a circuit including the first contact and the second contact, has an axis in parallel with a direction of a gap between the first contact and the second contact in a case in which the first contact and the second contact are in a non-contact state, and is provided so as to encircle the gap.

### Advantageous Effects of Invention

The present invention can address an arc generated between two contacts at a contact switch.

### BRIEF DESCRIPTION OF DRAWINGS

FIG. 1A illustrates a closed-circuit state of an arc binding mechanism according to a first embodiment.

FIG. 1B illustrates a closed-circuit state of an arc binding mechanism according to a first embodiment.

FIG. 2A illustrates the arc binding mechanism according to the first embodiment, with a movable plate and a movable contact being omitted.

FIG. 2B illustrates the arc binding mechanism according to the first embodiment, with a movable plate and a movable contact being omitted.

FIG. 3 illustrates an open-circuit state of the arc binding mechanism according to the first embodiment.

FIG. 4 illustrates a magnetic field generated by a linear current.

FIG. 5A illustrates the arc binding mechanism according to a second embodiment.

FIG. 5B illustrates the arc binding mechanism according to a second embodiment.

FIG. 6A illustrates a closed-circuit state of an arc binding mechanism according to a third embodiment.

FIG. 6B illustrates a closed-circuit state of an arc binding mechanism according to a third embodiment.

FIG. 7 illustrates an open-circuit state of the arc binding mechanism according to the third embodiment.

FIG. 8A illustrates a closed-circuit state of an arc binding mechanism according to a fourth embodiment.

FIG. 8B illustrates a closed-circuit state of an arc binding mechanism according to a fourth embodiment.

FIG. 9A illustrates the arc binding mechanism according to the fourth embodiment, with a movable plate and a movable contact being omitted.

FIG. 9B illustrates the arc binding mechanism according to the fourth embodiment, with a movable plate and a movable contact being omitted.

FIG. 10 illustrates an open-circuit state of the arc binding mechanism according to the fourth embodiment.

FIG. 11A illustrates a closed-circuit state of an arc binding mechanism according to a fifth embodiment.

FIG. 11B illustrates a closed-circuit state of an arc binding mechanism according to a fifth embodiment.

FIG. 11C illustrates a closed-circuit state of an arc binding mechanism according to a fifth embodiment.

FIG. 12 illustrates an open-circuit state of the arc binding mechanism according to the fifth embodiment.

FIG. 13A illustrates an arc binding mechanism according to a sixth embodiment.

FIG. 13B illustrates an arc binding mechanism according to a sixth embodiment.

FIG. 14 is a plan view showing the interior of a thermal protector in the closed-circuit state.

FIG. 15 is a sectional view of FIG. 14 taken along line J-J.

FIG. 16 is a sectional view of the thermal protector in the open-circuit state.

### DESCRIPTION OF EMBODIMENTS

Hereinafter, the present invention is described based on illustrated embodiments. Note that the present invention is not limited to the embodiments described below.

### First Embodiment

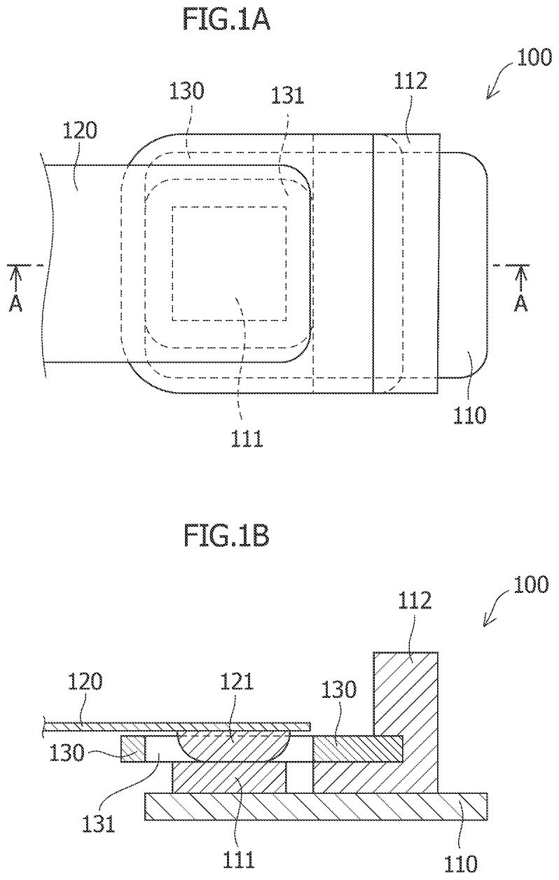

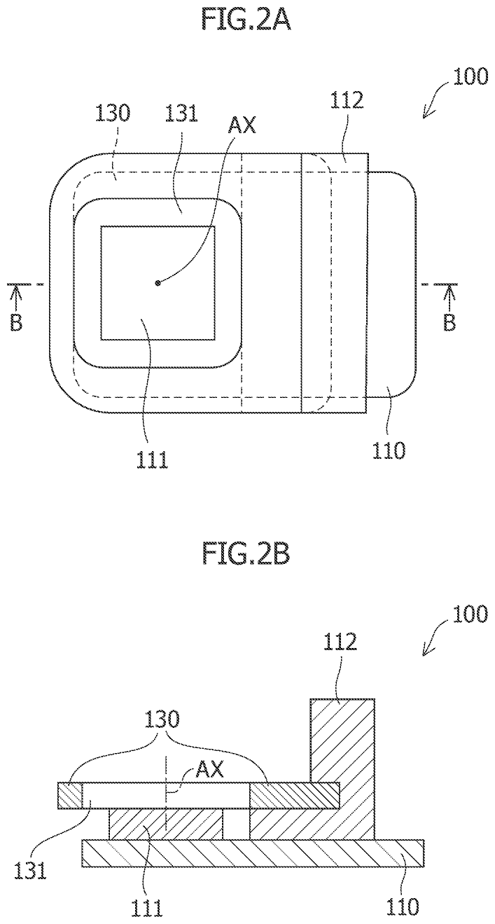

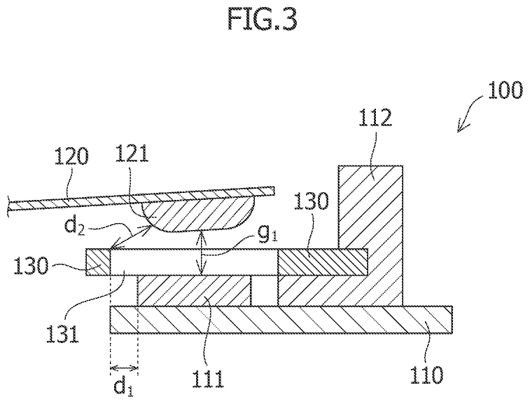

FIGS. 1A to 3 show an arc binding mechanism 100 according to this embodiment. FIG. 1A is a plan view of the arc binding mechanism 100 in a switch-closed state (a state where two contacts are in contact with each other). FIG. 1B is a sectional view of FIG. 1A taken along line A-A. FIG. 2A is a plan view of the arc binding mechanism 100; a movable plate 120 and a movable contact 121 described later are not illustrated. FIG. 2B is a sectional view of FIG. 2A taken along line B-B. FIG. 3 is a sectional view of the arc binding mechanism 100 in a switch-open state (a state in which the two contacts are not in contact).

The arc binding mechanism 100 includes: a fixed contact 111 attached to a surface of a base plate 110; and a movable contact 121 that is attached to a movable plate 120 provided to face the base plate 110 and is capable of being contacted with, and separated from, the fixed contact 111. The movable plate 120 is provided with a drive mechanism (not shown) for moving the movable plate 120. Examples of the drive mechanism include a bimetal element, and an electromagnet. The fixed contact 111 and the movable contact 121 are components of a contact switch, and are electrically connected to an electric machine (not shown), such as a motor.

The arc binding mechanism 100 further includes a substantially ring-shaped arc binder 130 made of a magnetic material. On the surface of the base plate 110, the arc binder 130 is supported by a support portion 112 provided at an interval from the fixed contact 111. The fixed contact 111 is positioned out of a hollow portion 131 of the arc binder 130 irrespective of whether the switch is in an open state or a closed state. At least part of the movable contact 121 is positioned in the hollow portion 131 in the switch-closed state. The movable contact 121 is positioned out of the hollow portion 131 in the switch-open state.

The arc binder 130 is provided at a position corresponding to a gap g₁ between the fixed contact 111 and the movable contact 121 in the switch-open state. Specifically, the arc binder 130 is disposed so that its axis AX is in parallel with the direction of the gap g₁ and the arc binder 130 encircles the gap g₁.

The arc binder 130 is electrically insulated from an electric circuit that includes the fixed contact 111 and the movable contact 121. The arc binder 130 is disposed so as not to be in contact with the movable plate 120 and the movable contact 121. The positional relationship is configured so that in the switch-open state (open stable state), the sum of the distance d₁ between the arc binder 130 and the fixed contact 111, and the distance d₂ between the arc binder 130 and the movable contact 121 is larger than the gap g₁. That is, it is as in the following expression.

d₁+d₂>g₁ (1)

Each of the distances d₁ and d₂ is a spacing as an insulation distance.

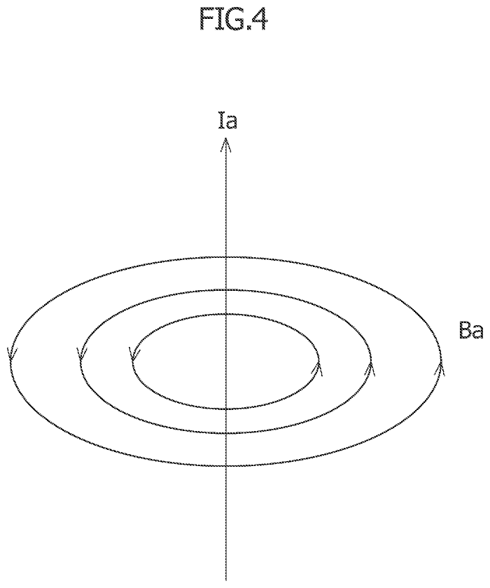

According to this embodiment, an arc generated between the two contacts when the switch is switched from one of the closed state and the open state to the other state is bound in the arc binder 130 magnetized by being subjected to the action of a magnetic field generated by the arc. This point is described with reference to FIG. 4.

As shown in FIG. 4, in general, a magnetic field Ba in the direction according to the right-handed screw rule is generated around linear current Ia. In this embodiment, the linear current 1a is assumed as the arc generated between the two contacts, and generation of a magnetic field around the arc similar to the magnetic field Ba is utilized. In this embodiment, the arc binder 130 is magnetized by being subjected to the action of the magnetic field generated around the arc, a Lorentz force affects charged particles of the arc, and the arc is bound in the substantially ring-shaped arc binder 130. Accordingly, the probability that the arc blows in an unintentional direction and breaks components around the switch can be reduced.

Note that the arc binder 130 is at a temperature much lower than an arc's temperature that may be 1,000 degrees centigrade. Accordingly, an arc binding effect can be expected according to which it is difficult for the arc to approach the arc binder 130, also by the thermal pinch effect.

At a typical contact switch, a Lorentz force that is caused by a strong external magnetic field around the switch and is applied to an arc causes the arc to blow to a conductive component and an insulator around the contacts, possibly damaging them. However, in this embodiment, the arc is bound by the arc binder due to the magnetic shielding effect. Accordingly, stable current breaking can be achieved even with presence of the external magnetic field. The arc caused when current is broken is stable in the arc binder, which can prevent the materials around the contacts from being carbonized, and prevent the arc from abnormally increasing due to occurrence of gas. As a result, the durability of the contacts can be improved, which can secure the reliability of the switch.

When an inductive load is connected to both the contacts, the arc tends to be large due to the counter electromotive force. Current flows through a coil constituting the inductive load, which strengthens the external magnetic field around the switch. Even in such a case, according to this embodiment, the arc is bound by the arc binder due to the magnetic shielding effect as described above. Accordingly, stable current breaking can be achieved even with presence of the external magnetic field.

Preferably, the magnetic material of which the arc binder 130 is made is a soft magnetic material, i.e., one that has a high magnetic permeability. In a case of iron, in particular, it is preferable to adopt what is made of a material, such as an electromagnetic soft iron with soft magnetism, having been subjected to appropriate heat treatment. In a case of soft magnetic ferrite, it is preferable to adopt a manganese-zinc or nickel zinc material that has a wide temperature range and, in particular, is usable at high temperature. Permalloy may also be adopted.

The arc binder 130 can be fixed by integral molding with a resin when the base plate 110 is provided with the support portion 112, in a simultaneous manner. Alternatively, after the arc binder 130 is molded, this arc binder may be fixed to the support portion 112 with an adhesive, preferably a thermosetting adhesive. Although not shown, the arc binder may be fixed to the support portion 112 by swaging, engaging, or welding. Alternatively, the arc binder 130 is not integrally molded with the support portion 112, the arc binder 130 may be made of a magnetic material, and the support portion 112 may be made of a non-magnetic material.

### Second Embodiment

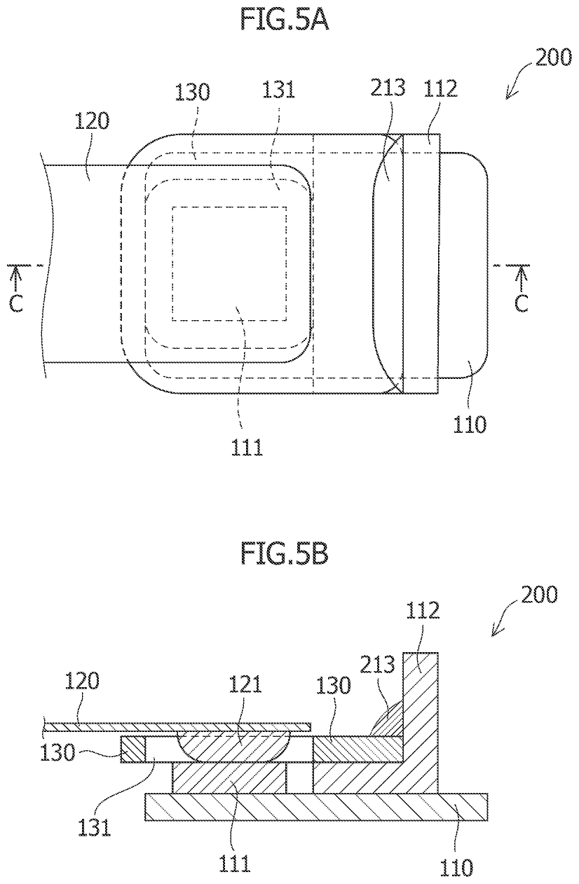

FIG. 5A is a plan view showing an arc binding mechanism 200 according to this embodiment. FIG. 5B is a sectional view of FIG. 5A taken along line C-C. The same elements as those in the first embodiment are assigned the same signs. Their detailed description is omitted. Unlike the first embodiment, this embodiment describes an example in which the arc binder 130 is fixed to the support portion 112 with an adhesive 213. In view of thermal effects of the arc, it is preferable to use a thermosetting adhesive, such as epoxy resin.

### Third Embodiment

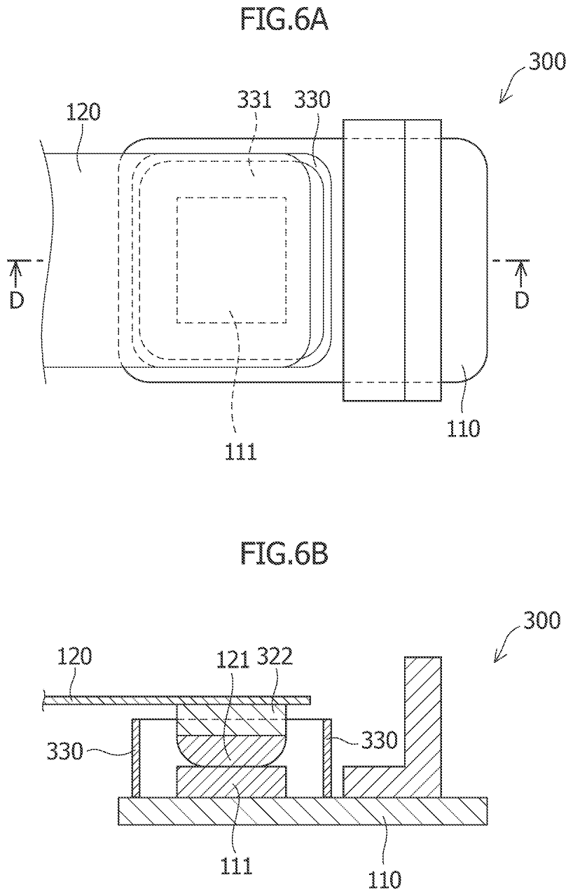

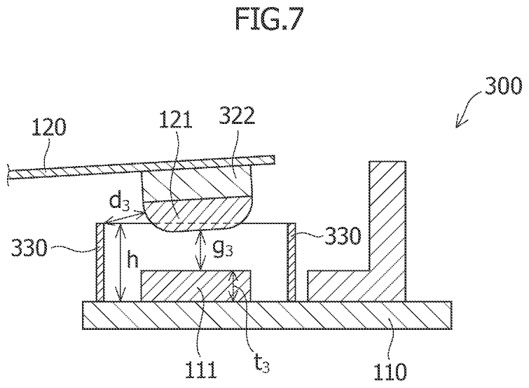

FIGS. 6A, 6B, and 7 show an arc binding mechanism 300 according to this embodiment. FIG. 6A is a plan view of the arc binding mechanism 300 in a switch-closed state. FIG. 6B is a sectional view of FIG. 6A taken along line D-D. FIG. 7 is a sectional view of the arc binding mechanism 300 in a switch-open state.

An arc binder 330 is formed to have a pipe shape that is a type of a substantial ring shape so as to have a larger dimension in the axial direction than the arc binder 130 in the first embodiment. An end portion of the arc binder 330 on a fixed contact side in the axial direction is fixed to the base plate 110. The dimension h of the arc binder 330 in the axial direction is greater than the sum of the gap g₃ between the fixed contact 111 and the movable contact 121 in the switch-open state (open stable state) and the dimension t₃ of the fixed contact 111 in the axial direction of the arc binder 330. That is, as in the following expression.

h>g₃+t₃ (2)

Thus, the gap g₃ is entirely encircled by the arc binder 330.

A base portion 322 is provided between the movable plate 120 and the movable contact 121. The clearance between the movable plate 120 and the movable contact 121 is secured to be greater than that in the first embodiment. Accordingly, the movable plate 120 can be prevented from interfering with the arc binder 330.

The spatial distance d₃ between the arc binder 330 and the movable contact 121 in the switch-open state (open stable state) is described. If the diameter of the arc binder 330 is increased, the spatial distance d₃ can be large. On the other hand, if the diameter of the arc binder 330 is relatively large, the distance between the center of the arc caused between the two contacts and the arc binder 330 is also large. As a result, the magnetic field at the arc binder 330 becomes weak, and the arc binding effect becomes small accordingly. Consequently, it is preferable that the spatial distance d₃ be greater than the gap g₃ or equal to the gap g₃ as shown in the following expression.

d₃g₃ (3)

Thus, with a certain degree of the dimension h, it is difficult to secure the spatial distance d₃, but the spatial distance d₃ in the open-circuit state can be greater than or equal to the gap g₃.

According to this embodiment, since the dimension h of the arc binder 330 in the axial direction is greater than the gap g₃, the arc binding effect can be expected to be further improved. Note that instead of the base portion 322 being provided, the movable plate may be configured not to interfere with the arc binder by bending the movable plate.

The pipe-shaped arc binder 330 can be formed by press working in a case of using a metal, such as iron, for example, and can be formed by compressing or injecting powders in a case of using ferrite.

### Fourth Embodiment

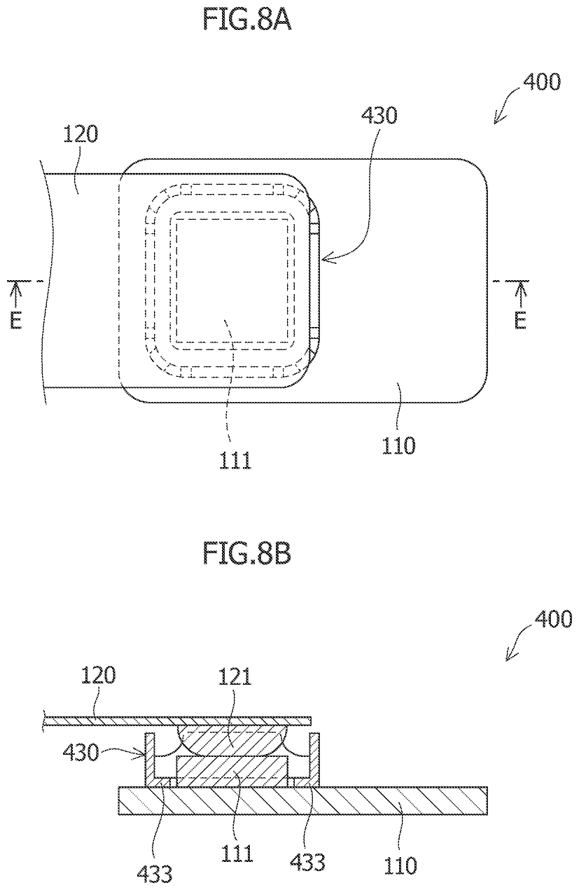

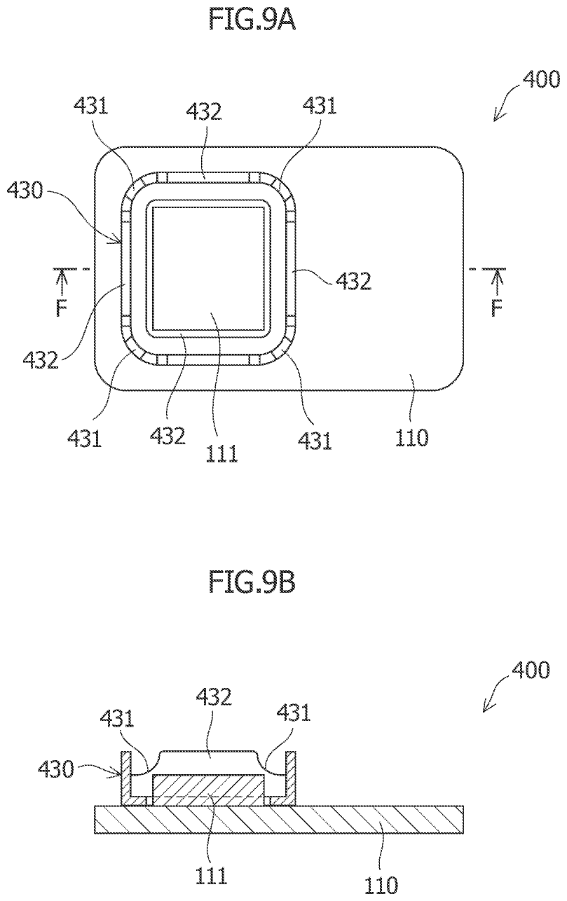

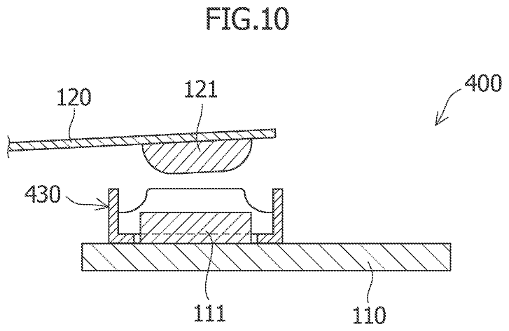

FIGS. 8A to 10 show an arc binding mechanism 400 according to this embodiment. FIG. 8A is a plan view of the arc binding mechanism 400 in a switch-closed state. FIG. 8B is a sectional view of FIG. 8A taken along line E-E. FIG. 9A is a plan view of the arc binding mechanism 400; a movable plate 120 and a movable contact 121 are not shown. FIG. 9B is a sectional view of FIG. 9A taken along line F-F. FIG. 10 is a sectional view of the arc binding mechanism 400 in a switch-open state.

An arc binder 430 has a substantially rectangular ring shape as a whole. An end portion of the arc binder 430 on the fixed contact side in the axial direction is fixed to the base plate 110. Four corner portions 431, and four edge portions 432 each interposed between adjacent two of the corner portions 431 are provided at the end portion of the arc binder 430 on the movable contact side in the axial direction. The edge portions 432 more protrude on the movable contact side in the axial direction than the corner portions 431. The gap between the fixed contact 111 and the movable contact 121 in the switch-open state is encircled by the four edge portions 432.

The arc binder 430 is magnetized in the axial direction. Accordingly, the magnetic force is concentrated to the four edge portions 432, which protrude more toward the movable contact in the axial direction than the corner portions 431. Since the gap is encircled by the four edge portions 432, the arc binding effect can be obtained.

According to this embodiment, in addition to the magnetic effect similar to that in the first embodiment, the following advantageous effect is also obtained. That is, the end portion of the arc binder 430 on the fixed contact side in the axial direction is fixed to the base plate 110. Accordingly, while no opening portion resides on the fixed contact side of the arc binder 430 in the axial direction, a relatively large gap is present between the corner portions 431 and the movable plate 120 in the switch-closed state. Thus, even when the movable plate 120 moves to achieve the switch-open state, air flows thereinto from the gap. Accordingly, the area around the contacts momentarily has a negative pressure, and the probability that the arc will become unstable can be reduced.

As shown in FIGS. 8A and 8B, at the end portion of the arc binder 430 on the fixed contact side in the axial direction, an extending portion 433 that extends inward in the radial direction may be provided. The extending portion 433 is provided so as not to interfere with the fixed contact 111. By providing the extending portion 433, the fixation strength of the arc binder 430 can be improved.

Not all the four corner portions 431 are necessarily positioned closer to the fixed contact 111 along the axial direction than the edge portions 432. It is only required that at least one corner portion 431 be positioned closer to the fixed contact 111 along the axial direction than the edge portions 432. Alternatively, the positions of the corner portions 431 in the axial direction may be the same as the positions of the edge portions 432 in the axial direction.

### Fifth Embodiment

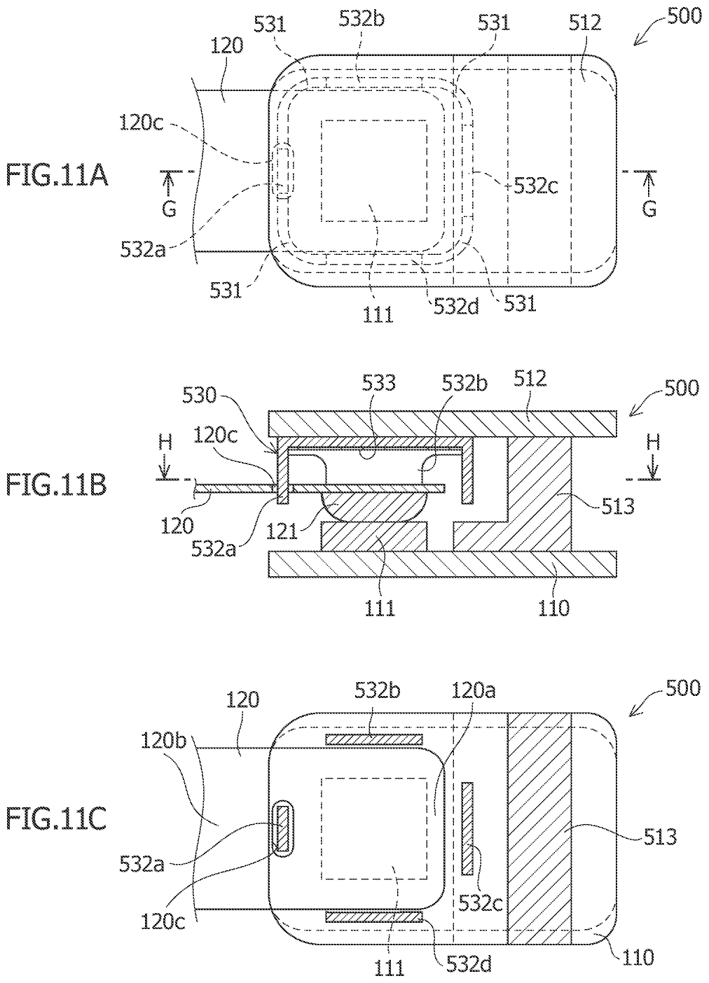

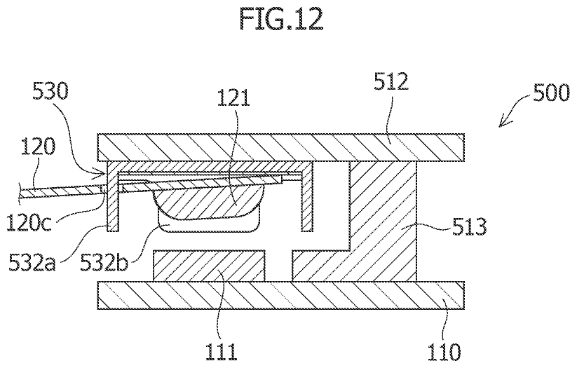

FIGS. 11A, 11B, 11C, and 12 show an arc binding mechanism 500 according to this embodiment. FIG. 11A is a plan view of the arc binding mechanism 500 in a switch-closed state. FIG. 11B is a sectional view of FIG. 11A taken along line G-G. FIG. 11C is a sectional view of FIG. 11B taken along line H-H. FIG. 12 is a sectional view of the arc binding mechanism 500 in a switch-open state.

A second base plate 512 is provided so as to face the base plate 110. The second base plate 512 is supported by a support portion 513 provided for the base plate 110. An arc binder 530 has a substantially rectangular ring shape. Its end portion on the movable contact side in the axial direction is fixed to the second base plate 512. On the fixed contact side in the axial direction, a surface with an opening is formed.

Four corner portions 531, and four edge portions 532a to 532d each interposed between adjacent two of the corner portions 531 are provided at the end portion of the arc binder 530 on the fixed contact side in the axial direction. The edge portions 532a to 532d more protrude toward the fixed contact 111 in the axial direction than the corner portions 531.

One end of the first edge portion 532a is connected to one end of the second edge portion 532b via the corner portion 531. The other end of the second edge portion 532b is connected to one end of the third edge portion 532c via the corner portion 531. The other end of the third edge portion 532c is connected to one end of the fourth edge portion 532d via the corner portion 531. The other end of the fourth edge portion 532d is connected to the other end of the first edge portion 532a via the corner portion 531.

A direction in which the first edge portion 532a and the third edge portion 532c face each other is in parallel with the longitudinal direction of the movable plate 120 in which a distal end portion 120a and a proximal end portion 120b of the movable plate 120 are aligned. The first edge portion 532a is positioned closer to the proximal end portion 120b. The third edge portion 532c is positioned closer to the distal end portion 120a.

A clearance hole 120c is provided at the proximal end portion 120b of the movable plate 120. The first edge portion 532a penetrates through the inside of the clearance hole 120c. The clearance hole 120c, and the two corner portions 531 at the opposite ends of the first edge portion 532a prevent the movable plate 120 from interfering with the arc binder 530.

As described above, even in a case in which the attachment portion of the arc binder 530 is configured at the end portion on the movable contact side in the axial direction instead of the end portion on the fixed contact side in the axial direction, the arc binding effect can be achieved. Note that an insulating treatment may be performed by forming a sheet-shaped insulating film 533 at an end portion of the arc binder 530 on the movable contact side in the axial direction so as to face the movable plate 120.

### Sixth Embodiment

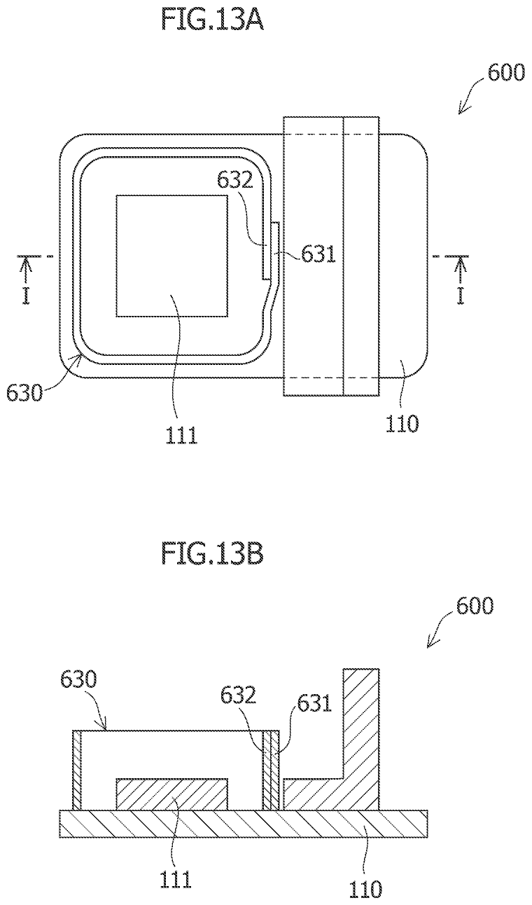

FIGS. 13A and 13B show an arc binding mechanism 600 according to this embodiment. FIG. 13A is a plan view of the arc binding mechanism 600; a movable plate and a movable contact are not shown. FIG. 13B is a sectional view of FIG. 13A taken along line I-I.

An arc binder 630 is formed by cutting out a sheet-shaped magnetic material with a predetermined width, and winding the body into a pipe shape. Opposite end portions 631 and 632 in the circumferential direction that overlap with each other can be joined by welding or swaging.

### Example of Application

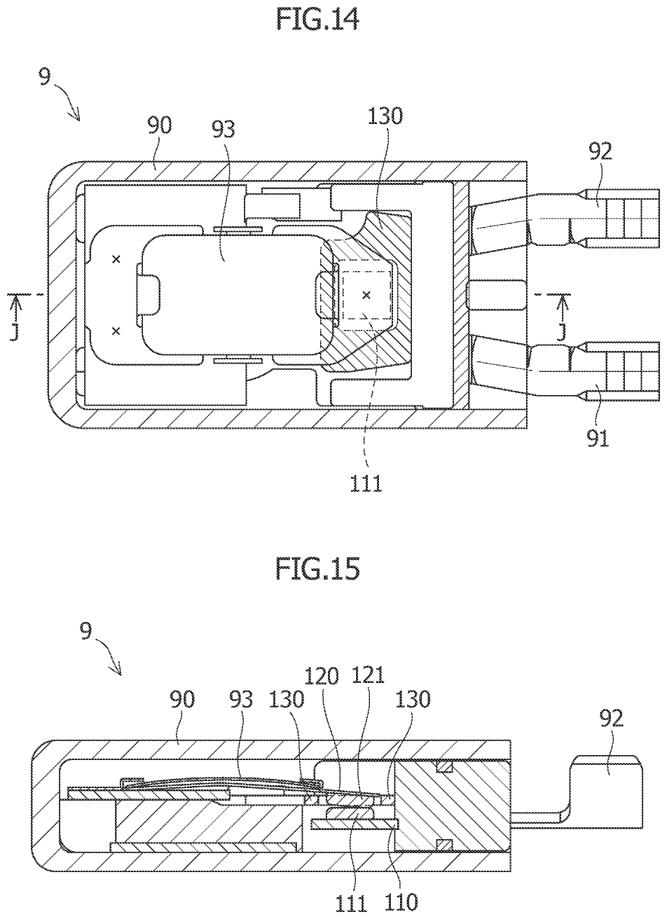

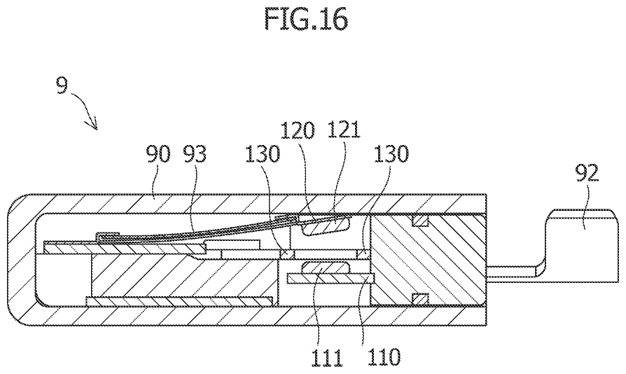

FIGS. 14 to 16 show situations in which the arc binding mechanism 100 according to the first embodiment is attached to a thermal protector (temperature switch) that includes a bimetallic element. FIG. 14 is a plan view showing the inside of the thermal protector in a closed-circuit state. FIG. 15 is a sectional view of FIG. 14 taken along line J-J. FIG. 16 is a sectional view of the thermal protector in an open-circuit state.

The thermal protector 9 includes the arc binding mechanism 100 in a case 90. A first lead 91 of the thermal protector 9 is electrically connected to the fixed contact 111. A second lead 92 is electrically connected to the movable contact 121. The movable plate 120 is configured to move, with a bimetallic element 93 being adopted as a driver.

Thus, the arc binding mechanism 100 is applicable to the thermal protector 9, which is a type of the contact switch, in order to achieve the arc binding effect.

[Other Matters]

The arc binding mechanism may be provided also for a transfer contact that combines a normally open contact and a normally closed contact. For example, the arc binding mechanism 400 of the fourth embodiment may be provided for each of the normally open contact and the normally closed contact. Alternatively, in the fifth embodiment (FIGS. 11A, 11B, 11C, and 12), a movable contact different from the movable contact 121 may be provided on the upper surface of the movable plate 120, and a fixed contact capable of being contacted with and separated from this movable contact may be provided on the second base plate 512. Also in a toggle switch, for example, the arc binder 130 according to the first embodiment may be provided for each of a normally open contact and a normally closed contact.

The embodiments having been described so far are applicable generally to contact switches, in particular, contact switches that include various switches for breaking a relatively large current, and relays, such as electromagnetic relays. That is, irrespective of the types of the drive mechanisms of the contact switches, the embodiments having been described so far are applicable.

The embodiments of the present invention are thus described above. However, the present invention is not limited to the embodiments having already been described, and can be variously modified and changed based on the technical concept of the present invention.

### REFERENCE SIGNS LIST

100, 200, 300, 400, 500, 600 Arc Binding Mechanism
110 Base Plate
111 Fixed Contact
112 Support Portion
120 Movable Plate
121 Movable Contact
130, 330, 430, 530, 630 Arc Binder
g₁, g₃ Gap

1. An arc binding mechanism, comprising:
a first contact and a second contact that are capable of being contacted and separated; and
a substantially ring-shaped arc binder that is made of a magnetic material, is electrically insulated from a circuit including the first contact and the second contact, has an axis in parallel with a direction of a gap between the first contact and the second contact in a case in which the first contact and the second contact are in a non-contact state, and is provided so as to encircle the gap.

2. The arc binding mechanism according to claim 1, wherein when the first contact and the second contact are in the non-contact state, a sum of a spatial distance between the arc binder and the first contact, and a spatial distance between the arc binder and the second contact is greater than the gap.

3. The arc binding mechanism according to claim 1, wherein the arc binder is made of soft magnetic iron.

4. The arc binding mechanism according to claim 1, wherein the arc binder is made of soft magnetic ferrite.

5. The arc binding mechanism according to claim 1, wherein the arc binder has a pipe shape, and one end portion of the arc binder in an axial direction is attached to a base plate onto which the first contact is fixed.

6. The arc binding mechanism according to claim 5, wherein
an extending portion that extends inward in a radial direction is provided at the one end portion of the arc binder in the axial direction, and
the extending portion is attached to the base plate on which the first contact is fixed.

7. The arc binding mechanism according to claim 5 or 6, wherein
the arc binder has a substantially rectangular ring shape,
four corner portions, and four edge portions each interposed between adjacent two of the corner portions are provided at one end portion of the arc binder on the second contact side in the axial direction, and
at least one corner portion is disposed closer to the first contact in the axial direction than the edge portions.

8. The arc binding mechanism according to claim 1, wherein
the first contact is a fixed contact fixed on a first base plate,
a second base plate is provided so as to face the first base plate,
one end portion of the arc binder in the axial direction is attached to the second base plate,
the second contact is a movable contact fixed on a movable plate, and
a clearance hole is formed in the arc binder so as to prevent the movable plate from interfering.

9. The arc binding mechanism according to claim 1, wherein the first contact and the second contact are temperature switch components that include a bimetallic element.

10. The arc binding mechanism according to claim 1, wherein the first contact and the second contact are electromagnetic relay components.
